(19) United States
(12) Patent Application Publication
(10) Pub. No.: US 2023/0343937 A1
(43) Pub. Date: Oct. 26, 2023

(54) SILICON-CARBON COMPOSITE PARTICLE, NEGATIVE ELECTRODE ACTIVE MATERIAL, AND NEGATIVE ELECTRODE, ELECTROCHEMICAL APPARATUS, AND ELECTRONIC APPARATUS CONTAINING SAME

(71) Applicant: Ningde Amperex Technology Limited, Ningde (CN)

(72) Inventors: Daoyi JIANG, Ningde (CN); Zhihuan CHEN, Ningde (CN)

(73) Assignee: Ningde Amperex Technology Limited, Ningde (CN)

(21) Appl. No.: 18/342,020

(22) Filed: Jun. 27, 2023

Related U.S. Application Data
(63) Continuation of application No. PCT/CN2020/140292, filed on Dec. 28, 2020.

(51) Int. Cl. H01M 4/36; H01M 4/587; H01M 4/38; H01M 4/134; H01M 4/133; C01B 33/02

(52) U.S. Cl. CPC H01M 4/366; H01M 4/587; H01M 4/386; H01M 4/134; H01M 4/133; C01B 33/02; H01M 2004/021

(57) ABSTRACT

A silicon-carbon composite particle includes a silicon-based particle and a plurality of graphite particles on surface of the silicon-based particle, where the graphite particles have a particle size of M μm, the silicon-based particle has a particle size of N μm, M<N, and 2<N≤10. Also, a preparation method of silicon-carbon composite particle. A lithium-ion battery prepared using the active material containing the silicon-carbon composite particles as the negative electrode has good cycling performance and low swelling rate.

### CROSS REFERENCES TO RELATED APPLICATIONS

This application is a continuation application of PCT/CN2020/140292, filed on Dec. 28, 2020, the disclosure of which is hereby incorporated by reference in its entirety.

### TECHNICAL FIELD

This application relates to the field of energy storage, and specifically to a silicon-carbon composite particle and a negative electrode active material containing the same. Further, this application also relates to a negative electrode, an electrochemical apparatus, and an electronic apparatus containing the negative electrode active material.

### BACKGROUND

With a gram capacity of up to 1500 to 4200 mAh/g, silicon-based negative electrode materials are considered as the most promising next-generation lithium-ion negative electrode materials for application. However, silicon has low conductivity (>108 Ω·cm), and during charging and discharging, has a volume expansion around 300% and an unstable solid electrolyte interface (SEI) film, which to some extent hinders further application of the silicon-based negative electrode material. In addition, in a system of silicon material mixed with graphite, volume expansion and contraction of silicon occurs during a process of lithium intercalation and deintercalation, and it is difficult to bind the pores formed between silicon and graphite by adhesion force alone, and thus electrical contact failure occurs. Currently, the industry generally uses long-range conductive agents (such as carbon nanotubes and vapor deposited carbon fibers) for connecting graphite and silicon to form a good electron conductive network, thus greatly improving the cycling of silicon negative electrodes. Currently, conductive agents commonly used are CMC dispersions of carbon nanotubes. The CMS dispersion is directly added during a slurry preparation process of a negative electrode active material. However, due to the extremely high viscosity of CMC dispersions of carbon nanotubes (>10000 mpa·s), addition of a CMC dispersion to the slurry can result in a low solid content of the slurry (<40%) and is very likely to cause an increase in viscosity of the slurry and gelation, leading to poor consistency in coating. Therefore, an amount of carbon nanotubes used is limited, especially under conditions of high silicon content, so use of carbon nanotubes is greatly restricted.

### SUMMARY

In view of this, this application provides a silicon-carbon composite particle with good cycling performance and a low swelling rate, its preparation method, and a negative electrode active material. This application further provides a negative electrode, an electrochemical apparatus, and an electronic apparatus containing the negative electrode active material.

In a first aspect, this application provides a silicon-carbon composite particle. The silicon-carbon composite particle includes a silicon-based particle and a plurality of graphite particles on surface of the silicon-based particle, where the graphite particles have a particle size of M μm, the silicon-based particle has a particle size of N μm, M<N, and 2<N≤10.

In this application, in consideration of the overall design of the silicon negative electrode active material, graphite particles and silicon-based particles are compounded into secondary particles using granulation, thus improving the bonding between graphite particles and silicon-based particles and making graphite particles and silicon-based particles have good electrical contact. The secondary particles formed by graphite particles and silicon-based particles can also effectively reduce pores formed due to the expansion of silicon-based particles, thus effectively reducing the cycling swelling performance of the battery cell. In addition, size matching between graphite primary particles and the silicon-based particles enables more graphite to surround the silicon-based particles to provide more contact points, thereby facilitating the integrity of the granulation morphology and achieving excellent cell cycling and lower swelling performance.

According to some embodiments of this application, the number of graphite particles present on surface of a single silicon-based particle is W, where W≥3. According to some further embodiments of this application, and N satisfies the following condition: 3≤N≤10. According to some further embodiments of this application, 0.1≤M/N≤0.99. According to some further embodiments of this application, the graphite particles have an aspect ratio of 3 to 10.

According to some embodiments of this application, based on a weight of the silicon-carbon composite particles, a percentage of element silicon is 15% to 40%; and based on the weight of the silicon-carbon composite particles, a percentage of element carbon is 40% to 85%. According to some embodiments of this application, the graphite particles include primary particles of graphite, sourced from one of petroleum coke graphite, coal-based coke graphite, or any combination thereof. The silicon-based particle includes at least one of a silicon-containing compound, elemental silicon, or a mixture thereof. According to some embodiments of this application, amorphous carbon is provided between the silicon-based particle and the graphite particles. According to some further embodiments of this application, the silicon-based particle further contains element lithium and/or magnesium.

According to some embodiments of this application, the silicon-carbon composite particles have one or more of the following characteristics: the particle size of the silicon-carbon composite particles is less than or equal to 30 μm; particle size distribution of the silicon-carbon composite particles satisfies: 0.3≤Dn10/Dv50≤1; and in an X-ray diffraction pattern of the silicon-carbon composite particles, a highest intensity value is I2 when 2θ is in the range from 28.0° to 29.0°, and the highest intensity value is I1 when 2θ is in the range from 20.5° to 21.5°, where 0<I2/I1≤5.

According to some embodiments of this application, the particle size refers to a median particle size.

In a second aspect, this application provides a negative electrode active material including the silicon-carbon composite particles according to the first aspect of this application.

According to some embodiments of this application, the negative electrode active material further includes an oxide MeOy layer and/or a polymer layer, the oxide MeOy layer coating at least a portion of the silicon-carbon composite particle, where Me includes at least one of Al, Si, Ti, Mn, V, Cr, Co, or Zr, and y is 0.5 to 3. According to some embodiments of this application, the oxide MeOy layer has a thickness of 0.5 nm to 100 nm. According to some embodiments of this application, the oxide MeOy layer includes a first carbon material. According to some embodiments of this application, the polymer layer includes a second carbon material. According to some embodiments of this application, the first carbon material and the second carbon material are the same or different, each independently including carbon nanotubes, carbon nanoparticles, carbon fibers, graphene, or any combination thereof. According to some embodiments of this application, the polymer layer coats at least a portion of the silicon-carbon composite particle or the oxide MeOy layer.

According to some embodiments of this application, the polymer layer includes polyvinylidene fluoride and its derivatives, carboxymethyl cellulose and its derivatives, sodium carboxymethyl cellulose and its derivatives, polyvinylpyrrolidone and its derivatives, polyacrylic acid and its derivatives, polystyrene-butadiene rubber, polyacrylamide, polyimide, polyamideimide, or any combination thereof.

According to some embodiments of this application, based on a total weight of the negative electrode active material, a percentage of the first carbon material by weight is 0.1% to 10%; a percentage of element Me by weight is 0.005% to 1%; and a percentage of the polymer layer by weight is 0.05% to 5%.

In a third aspect, this application provides a preparation method of silicon-carbon composite particle, including the following steps:
(1) mixing graphite particles, silicon-based particles, and an organic carbon source material to form a mixture, where the graphite particles have a particle size of M μm, the silicon-based particles have a particle size of N μm, M<N, and 2<N≤10; and
(2) granulating and sintering the mixture formed in step (1).

According to some embodiments of this application, 3≤N≤10.

According to some embodiments of this application, the graphite particles have an aspect ratio of 3 to 10. According to some embodiments of this application, the graphite particles include primary particles of graphite, sourced from one of petroleum coke graphite, coal-based coke graphite, or any combination thereof. According to some embodiments of this application, the silicon-based particle includes at least one of a silicon-containing compound, elemental silicon, or a mixture thereof. According to some embodiments of this application, the silicon-based particle also contains element lithium and/or magnesium.

According to some embodiments of this application, in step (1), based on a weight of the mixture, the graphite particles are added in an amount of 32% to 67%. According to some embodiments of this application, in step (1), based on the weight of the mixture, the silicon-based particles are added in an amount of 25% to 50%. According to some embodiments of this application, in step (1), based on the weight of the mixture, the organic carbon source material is added in an amount of 8% to 18%.

According to some embodiments of this application, the organic carbon source material includes at least one of bitumen, resin, or tar. The applicants have found that the organic carbon source materials with relatively high softening points may form dots on surface of the silicon-based particles, thus forming better bonding sites. If the softening points are relatively low, these organic carbon source materials may form a coating on surface of the material, which is not conducive to forming a desired bonding structure. In addition, when an organic carbon source material with a relatively low softening point is used, formation of a large amount of incompletely cracked carbon on the surface of the material is not conducive to ion/electron transfer and leads to a decrease in the initial efficiency of the material. Therefore, the softening point of the organic carbon source material is preferably 200° C. to 250° C.

According to some embodiments of this application, the particle size refers to a median particle size.

The preparation method in this application can be used to obtain the silicon-carbon composite particles according to the first aspect of this application.

In a fourth aspect, this application provides a negative electrode including the negative electrode active material according to the second aspect of this application.

In a fifth aspect, this application provides an electrochemical apparatus including the negative electrode according to the fourth aspect of this application.

In a sixth aspect, this application provides an electronic apparatus including the electrochemical apparatus according to the fifth aspect of this application.

### BRIEF DESCRIPTION OF DRAWINGS

FIG. 1 is a schematic structural diagram of a silicon-carbon composite particle according to an embodiment of this application.

FIG. 2 is a scanning electron microscope (SEM) image of a silicon-carbon composite particle according to an embodiment of this application.

### DETAILED DESCRIPTION

The following further describes this application with reference to specific embodiments. It should be understood that these specific embodiments are merely intended to illustrate this application rather than to limit the scope of this application.

For brevity, this specification specifically discloses only some numerical ranges. However, any lower limit may be combined with any upper limit to form a range not expressly recorded; any lower limit may be combined with any other lower limit to form a range not expressly recorded; and any upper limit may be combined with any other upper limit to form a range not expressly recorded. In addition, each individually disclosed point or individual single numerical value may itself be a lower limit or an upper limit which ca be combined with any other point or individual numerical value or combined with another lower limit or upper limit to form a range not expressly recorded.

In the description herein, unless otherwise stated, “more than” and “less than” are inclusive of the present number, and “more” in “one or more” means two and more than two; and “at least one” means one or more, that is, one, two, and more than two.

In the context of this application, a particle size may refer to a median particle size.

Unless otherwise specified, the terms used in this application have well known meanings as commonly understood by persons skilled in the art. Unless otherwise specified, numerical values of parameters mentioned in this application may be measured by using various measurement methods commonly used in the art (for example, they may be measured by using the methods provided in some embodiments of this application).

In this application, Dv50 is a corresponding particle size in μm when a cumulative volume percentage of the silicon-based negative electrode active material reaches 50%.

In this application, Dn10 is a corresponding particle size in μm when a cumulative quantity percentage of the silicon-based negative electrode active material reaches 10%.

In this application, the terms “primary particles of graphite”, “primary graphite particles” and “graphite primary particles” are used interchangeably in the art.

I. Silicon-Carbon Composite Particles

This application provides a silicon-carbon composite particle. The silicon-carbon composite particle includes a silicon-based particle and a plurality of graphite particles on surface of the silicon-based particle, where the graphite particles have a particle size of M μm, the silicon-based particle has a particle size of N μm, M<N, and 2<N≤10.

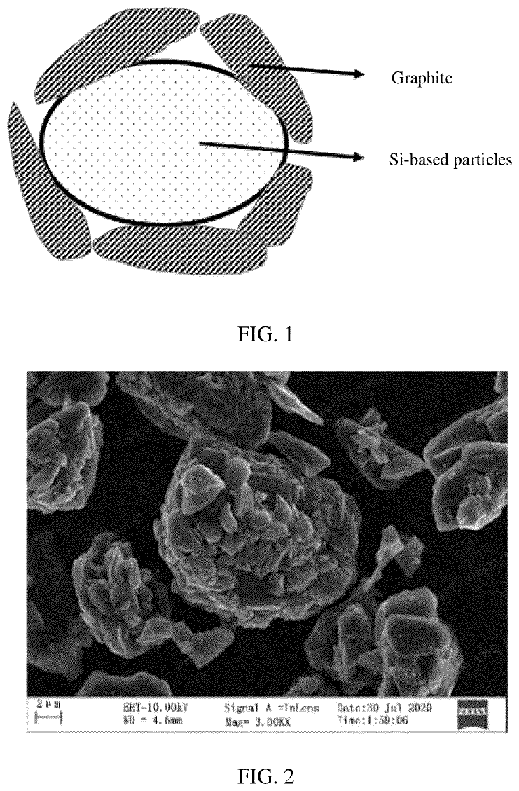

According to some embodiments of this application, the number of graphite particles present on surface of a single silicon-based particle is W, where W≥3. In some embodiments, W is 3, 4, 5, or 6. According to one embodiment, the number W of graphite particles present on surface of a single silicon-based particle is 5, as shown in FIG. 1. According to some embodiments of this application, the particle size N of the silicon-based particles satisfies the following condition: 3≤N≤10. In some embodiments, N is 3, 4, 5, 6, 7, 8, 9, or 10.

According to some embodiments of this application, a difference between the particle size of the graphite particles and the particle size of the silicon-based particles satisfies: 0.05<N−M<7. In some embodiments, the difference between the particle size of the graphite particles and the particle size of the silicon-based particles is 50 nm, 60 nm, 70 nm, 80 nm, 90 nm, 100 nm, 110 nm, 150 nm, 200 nm, 250 nm, 300 nm, 350 nm, 400 nm, 450 nm, 500 nm, 1 μm, 2 μm, 3 μm, 4 μm, 5 μm, or 6 μm. According to some embodiments of this application, the particle size M of the graphite particles and the particle size N of the silicon-based particles satisfy the following condition: 0.1≤M/N≤0.99. In some embodiments, M/N is 0.1, 0.15, 0.20, 0.25, 0.28, 0.30, 0.35, 0.40, 0.50, 0.60, 0.70, 0.75, 0.80, 0.85, 0.88, 0.90, 0.92, 0.95, 0.98, 0.99, or the like. According to some embodiments of this application, the graphite particles have an aspect ratio of 3 to 10. In some embodiments, the graphite particles have an aspect ratio of 3, 3.2, 3.6, 4.0, 4.4, 4.8, 5.2, 5.6, 6.0, 6.5, 6.8, 7.0, 7.5, 8.0, 8.5, or 9.0.

According to some embodiments of this application, based on a weight of the silicon-carbon composite particles, a percentage of element silicon is 15% to 40%. In some embodiments, a percentage of element silicon is 15%, 20%, 25%, 30%, 35%, or 40%. According to some embodiments of this application, based on a weight of the silicon-carbon composite particles, a percentage of element carbon is 40% to 85%. In some embodiments, a percentage of element carbon is 40%, 45%, 50%, 60%, 70%, 80%, or the like.

According to some embodiments of this application, the graphite particles include primary particles of graphite. According to some embodiments of this application, the primary particles of graphite may be sourced from one of petroleum coke graphite, coal-based coke graphite, or any combination thereof. According to some embodiments of this application, the silicon-based particle includes at least one of a silicon-containing compound, elemental silicon, or a mixture thereof. In some embodiments, the silicon-based particles include silicon oxide SiOₓ, X being 0.6 to 1.5. According to some embodiments of this application, the silicon-based particle further contains element lithium and/or element magnesium.

According to some embodiments of this application, amorphous carbon is provided between the silicon-based particle and the plurality of graphite particles, such as bituminous carbon. In this application, the term bituminous carbon refers to amorphous carbon produced by carbonization of bitumen.

According to some embodiments of this application, the silicon-carbon composite particles have a particle size less than or equal to 30 μm. According to some embodiments of this application, particle size distribution of the silicon-carbon composite particles satisfies: 0.3≤Dn10/Dv50≤1. According to some embodiments of this application, in an X-ray diffraction pattern of the silicon-carbon composite particles, a highest intensity value is I2 when 2θ is in the range from 28.0° to 29.0°, and the highest intensity value is I1 when 2θ is in the range from 20.5° to 21.5°, where 0<I2/I1≤5.

II. Negative Electrode Active Material

A negative electrode active material provided in this application includes the silicon-carbon composite particles according to the first aspect of this application.

According to some embodiments of this application, the negative electrode active material further includes an oxide MeOy layer, where the oxide MeOy layer coats at least a portion of the carbon-silicon composite particle, and Me includes at least one of Al, Si, Ti, Mn, V, Cr, Co, or Zr, and y is 0.5 to 3; and the oxide MeOy layer includes a first carbon material, where the first carbon material may include carbon nanotubes, carbon nanoparticles, carbon fibers, graphene, or any combination thereof. In some embodiments, based on a total weight of the negative electrode active material, a percentage of the first carbon material is 0.1% to 10%, such as 0.1%, 0.5%, 1%, 2%, 5%, or 10%. In some embodiments, based on the total weight of the negative electrode active material, a percentage of element Me by weight is 0.005% to 1%, such as 0.005%, 0.01%, 0.02%, 0.05%, 0.1%, 0.2%, 0.3%, 0.4%, or 0.5%. In some embodiments, the oxide MeOy layer has a thickness of 0.5 nm to 100 nm, such as 1 nm, 5 nm, 10 nm, 20 nm, 30 nm, 50 nm, or 100 nm.

In some embodiments, the negative electrode active material further includes a polymer layer, where the polymer layer coats at least a portion of the oxide MeOy layer, and the polymer layer includes a second carbon material, where the second carbon material may include carbon nanotubes, carbon nanoparticles, carbon fibers, graphene, or any combination thereof. In some embodiments, the polymer layer includes polyvinylidene fluoride and its derivatives, carboxymethyl cellulose and its derivatives, sodium carboxymethyl cellulose and its derivatives, polyvinylpyrrolidone and its derivatives, polyacrylic acid and its derivatives, polystyrene-butadiene rubber, polyacrylamide, polyimide, polyamideimide, or any combination thereof. In some embodiments, based on the total weight of the negative electrode active material, a percentage of the polymer layer by weight is 0.05% to 5%, such as 0.05%, 0.1%, 0.2%, 0.3%, 0.4%, 0.5%, 1%, 2%, 3%, 4%, or 5%.

III. Preparation Method of Silicon-Carbon Composite Particle

A preparation method of silicon-carbon composite particle provided in this application includes the following steps:
(1) mixing graphite particles, silicon-based particles, and an organic carbon source material to form a mixture, where the graphite particles have a particle size of M μm, the silicon-based particles have a particle size of N μm, M<N, and 2<N≤10; and
(2) granulating and sintering the mixture formed in step (1).

In this application, graphite particles and silicon-based particles are compounded in a way of granulation to form secondary particles, thus improving the bonding between graphite particles and silicon-based particles and making graphite particles and silicon-based particles have good electrical contact. The secondary particles formed by graphite particles and silicon-based particles can also effectively reduce pores formed due to the expansion of silicon-based particles, thus effectively reducing the cycling swelling performance of the battery cell. In addition, size matching between graphite particles and the silicon-based particles enables more graphite to surround the silicon-based particles to provide more contact points, thereby facilitating the integrity of the granulation morphology and achieving excellent cell cycling and lower swelling performance.

In some embodiments, the mixing in step (1) is performed using a mixer, such as a VC mixer. The mixing is performed for 15 minutes to 2 hours. In some embodiments, the granulation in step (2) includes processing the mixture formed in step (1) in a roller furnace or reactor at a speed of 5 r/min to 50 r/min. In some embodiments, the sintering in step (2) is performed in a non-oxidizing atmosphere, such as one or more of nitrogen, argon, or helium. In some embodiments, the sintering is performed at 600° C. to 1300° C., such as 800° C., 900° C., or 1000° C. In some embodiments, the organic carbon source includes at least one of bitumen, resin, or tar. The resin may be polyacrylonitrile, phenolic resin, polyvinyl chloride, or the like. According to some embodiments, the organic carbon source material has a softening point of 200° C. or more, preferably 200° C. to 250° C.

In some embodiments, in step (1), based on a weight of the mixture, the graphite particles are added in an amount of 32% to 67%, such as 32%, 35%, 40%, 42%, 45%, 50%, 55%, 58%, and 60%; the silicon-based particles are added in an amount of 25% to 50%, such as 25%, 28%, 30%, 32%, 35%, 40%, 45%, and 50%; and the organic carbon source material is added in an amount of 8% to 18%, such as 8%, 9%, 10%, 12%, 15%, 16%, and 18%.

The preparation method in this application can be used to obtain the silicon-carbon composite particles according to the first aspect of this application.

IV. Negative Electrode

The negative electrode provided in this application includes the negative electrode active material according to the second aspect of this application.

In this application, the negative electrode further includes a current collector, where the negative electrode active material is located on the current collector.

In some embodiments, the current collector includes copper foil, nickel foil, stainless steel foil, titanium foil, foamed nickel, foamed copper, polymer base coated with conductive metal, or a combination thereof.

V. Electrochemical Apparatus

Some embodiments of this application provide an electrochemical apparatus, where the electrochemical apparatus includes any apparatus in which electrochemical reactions take place.

In some embodiments, the electrochemical apparatus in this application includes a positive electrode having a positive electrode active material capable of occluding and releasing metal ions, the negative electrode according to this application, an electrolyte, and a separator disposed between the positive electrode and the negative electrode.

Negative Electrode

The negative electrode in the electrochemical apparatus of this application is the negative electrode described according to a fourth aspect of this application.

Positive Electrode

Materials, components and manufacturing methods that can be used for the positive electrode in some embodiments of this application include any technology disclosed in the prior art. In some embodiments, the positive electrode includes a current collector and a positive electrode active material layer located on the current collector. In some embodiments, the positive electrode active material includes but is not limited to lithium cobalt oxide (LiCoO₂), lithium-nickel-cobalt-manganese (NCM) ternary material, lithium iron phosphate (LiFePO₄), or lithium manganate (LiMn₂O₄).

In some embodiments, the positive electrode active material layer further includes a binder, and optionally includes a conductive material. The binder enhances binding between particles of the positive electrode active material, and binding between the positive electrode active material and the current collector. In some embodiments, the binder includes but is not limited to polyvinyl alcohol, hydroxypropyl cellulose, diacetyl cellulose, polyvinyl chloride, carboxylated polyvinyl chloride, polyvinyl fluoride, a polymer containing ethylene oxide, polyvinylpyrrolidone, polyurethane, polytetrafluoroethylene, poly(vinylidene fluoride), polyethylene, polypropylene, styrene-butadiene rubber, acrylic styrene-butadiene rubber, epoxy resin, or nylon.

In some embodiments, the conductive material includes but is not limited to: carbon-based materials, metal-based materials, conductive polymer, and a mixture thereof. In some embodiments, the carbon-based material is selected from natural graphite, artificial graphite, carbon black, acetylene black, Ketjen black, carbon fibers, or any combination thereof. In some embodiments, the metal-based material is selected from metal powder, metal fiber, copper, nickel, aluminum, or silver. In some embodiments, the conductive polymer is a polyphenylene derivative.

In some embodiments, the current collector may include but is not limited to aluminum.

The positive electrode can be prepared by a preparation method known in the art. For example, the positive electrode may be obtained by using the following method: mixing the active material, the conductive material, and the binder in a solvent to prepare an active material composition, and applying the active material composition on the current collector.

In some embodiments, the solvent may include but is not limited to N-methylpyrrolidone.

Electrolyte

The electrolyte that can be used in some embodiments of this application may be an electrolyte known in the prior art. In some embodiments, the electrolyte includes an organic solvent, a lithium salt, and an additive. The organic solvent of the electrolyte according to this application may be any organic solvent known in the prior art which can be used as a solvent of the electrolyte. An electrolytic salt used in the electrolyte according to this application is not limited, and may be any electrolytic salt known in the prior art. The additive of the electrolyte according to this application may be any additive that is known in the prior art and that may be used as an additive of the electrolyte. In some embodiments, the organic solvent includes but is not limited to ethylene carbonate (EC), propylene carbonate (PC), diethyl carbonate (DEC), ethyl methyl carbonate (EMC), dimethyl carbonate (DMC), propylene carbonate, or ethyl propionate. In some embodiments, the lithium salt includes at least one of an organic lithium salt or an inorganic lithium salt. In some embodiments, the lithium salt includes but is not limited to lithium hexafluorophosphate (LiPF₆), lithium tetrafluoroborate (LiBF₄), lithium difluorophosphate (LiPO₂F₂), lithium bistrifluoromethanesulfonimide LiN(CF₃SO₂)₂(LiTF SI), lithium bis(fluorosulfonyl)imide Li(N(SO₂F)₂)(LiF SI), lithium bis(oxalate) borate LiB(C₂O₄)₂(LiBOB) or lithium difluoro(oxalato)borate LiBF₂(C₂O₄)(LiDFOB). In some embodiments, a concentration of the lithium salt in the electrolyte ranges from about 0.5 mol/L to 3 mol/L, from about 0.5 mol/L to 2 mol/L, or from about 0.8 mol/L to 1.5 mol/L.

Separator

In some embodiments, a separator is provided between the positive electrode and the negative electrode to prevent a short circuit. A material and shape of the separator that can be used in some embodiments of this application is not specifically limited, and any technology disclosed in the prior art may be used for the separator.

In some embodiments, the separator includes a polymer or an inorganic substance formed by a material stable to the electrolyte of this application. For example, the separator may include a substrate layer and a surface treatment layer. The substrate layer is a non-woven fabric, film, or composite film of a porous structure. The substrate layer is made of at least one of polyethylene, polypropylene, polyethylene terephthalate, or polyimide. Specifically, a polypropylene porous film, a polyethylene porous film, polypropylene non-woven fabric, polyethylene non-woven fabric, or a polypropylene-polyethylene-polypropylene porous composite film may be selected.

The surface treatment layer is provided on at least one surface of the substrate layer, and the surface treatment layer may be a polymer layer or an inorganic substance layer, or may be a layer formed by mixing a polymer and an inorganic substance. The inorganic substance layer includes an inorganic particle and a binder. The inorganic particle includes at least one of aluminum oxide, silicon oxide, magnesium oxide, titanium oxide, hafnium oxide, tin oxide, ceria oxide, nickel oxide, zinc oxide, calcium oxide, zirconium oxide, yttrium oxide, silicon carbide, boehmite, aluminum hydroxide, magnesium hydroxide, calcium hydroxide, or barium sulfate. The binder includes at least one of polyvinylidene fluoride, a vinylidene fluoride-hexafluoropropylene copolymer, polyamide, polyacrylonitrile, polyacrylate, polyacrylic acid, polyacrylate, polyvinylpyrrolidone, polyvinyl ether, polymethyl methacrylate, polytetrafluoroethylene, or polyhexafluoropropylene. The polymer layer includes a polymer, and a material of the polymer includes at least one of polyamide, polyacrylonitrile, acrylate polymer, polyacrylic acid, polyacrylate, polyvinylpyrrolidone, polyvinyl ether, polyvinylidene fluoride, or poly(vinylidene fluoride-hexafluoropropylene).

In some embodiments, the electrochemical apparatus of this application includes but is not limited to all types of primary batteries, secondary batteries, fuel batteries, solar batteries, or capacitors. In some embodiments, the electrochemical apparatus is a lithium secondary battery. In some embodiments, the lithium secondary battery includes but is not limited to a lithium metal secondary battery, a lithium-ion secondary battery, a lithium polymer secondary battery, or a lithium-ion polymer secondary battery.

VI. Electronic Apparatus

The electronic apparatus in this application may be any apparatus using the electrochemical apparatus according to the fifth aspect of this application.

In some embodiments, the electronic apparatus may include but is not limited to a notebook computer, a pen-input computer, a mobile computer, an electronic book player, a portable telephone, a portable fax machine, a portable copier, a portable printer, a stereo headset, a video recorder, a liquid crystal television, a portable cleaner, a portable CD player, a mini-disc, a transceiver, an electronic notepad, a calculator, a memory card, a portable recorder, a radio, a standby power source, a motor, an automobile, a motorcycle, a power-assisted bicycle, a bicycle, a lighting appliance, a toy, a game console, a clock, an electric tool, a flash lamp, a camera, a large household battery, or a lithium-ion capacitor.

### Example: Preparation of Negative Electrode Material

1. Graphite particles, silicon-based particles and bitumen were mixed in a specified ratio for 2 hours with a cone mixer.

2. The mixed material was sifted to remove large particles.

3. The material sifted in step 2 was selected and transferred to a roller furnace for granulating, with a rotation speed of the roller furnace of 10 r/min and a treatment temperature of 600° C.

4. The granulated material was sintered (sintered at 850° C. for 2 hours under nitrogen atmosphere), sifted, demagnetized, and graded to obtain a finished product (DV99=28 μm).

I. Button Cell Test

The negative electrode material, conductive carbon black, and PAALi in a mass ratio of 80:10:10 were added with deionized water and stirred into a slurry. The slurry was applied with a scraper to form a coating layer with a thickness of 100 μm. The coating layer was dried in a vacuum drying oven for 12 hours at 85° C. A punching machine was used to cut discs with a diameter of 1 cm. A lithium metal plate was used as a counter electrode in a glove box, a Ceglard composite film was selected as a separator, and an electrolyte was added (in a dry argon atmosphere, LiPF₆ with a concentration of about 1.15 mol/L was added into a solvent obtained by mixing propylene carbonate (PC), ethylene carbonate (EC) and diethyl carbonate (DEC) (at a weight ratio of about 1:1:1) and mixed uniformly, and then 7.5% fluoroethylene carbonate (FEC) was added and mixed uniformly to obtain an electrolytic solution). A button cell was assembled. A LAND (LAND) series battery tester was used to perform a charge and discharge test on the battery to test its charge and discharge capacities.

Powder Property Test Method

Observation of microscopic morphology of powder particles: A scanning electron microscopy was used to observe the microscopic morphology of the powder and characterize coating of the material surface. The selected test instrument was OXFORD EDS (X-max-20 mm²), and the accelerated voltage was 10 KV. The focus was adjusted to start observation at a high magnification of 50 K, and particle agglomeration was mainly observed at low magnifications of 500 to 2000.

Specific Surface Area Test

At a constant low temperature, the amounts of gas adsorbed by the surface of a solid under different relative pressures were measured, and then an adsorption amount of a monomolecular layer of the sample was found based on the Brunauer-Emmett-Teller adsorption theory and its equation, to calculate a specific surface area of the solid.

$$BET equation : \frac{p}{w ( P 0 - p )} = \frac{1}{WmC} + ( c - 1 ) / ( WmC ) P / P 0$$

In the equation, W is the mass of gas adsorbed by a solid sample under relative pressure;
Wm is a gas saturated adsorption capacity covering a monomolecular layer;
slope: (c−1)/(WmC), intercept: 1/WmC, and total specific surface area: (Wm*N*Acs/M);
specific surface area: S=St/m, where m is a mass of the sample Acs: an average area occupied by each N₂ molecule was 16.2 A²; and
1.5 to 3.5 g of powder sample was weighed and put into a test sample tube of Tri Star II 3020 and tested after degassed at 200° C. for 120 minutes.

Particle Size Test

A powder sample of about 0.02 g was put into a 50 ml clean beaker, about 20 ml deionized water was added into the beaker, and a few drops of 1% surfactant were dripped in to completely disperse the powder in the water. Ultrasonic cleaning was performed in a 120 W ultrasonic cleaning machine for 5 minutes, and the particle size distribution was tested by using a MasterSizer 2000.

Tap Density

GB/T 5162-2006 “Metallic powders—determination of tap density” was adopted. First, a clean and dry 100 cm³ measuring cylinder with three-sided scale (the scale spacing was 1 cm³, and the measurement accuracy was ±0.5 cm³) was weighed as M g, and then, a specified mass of the powder sample was added so that the scale of the powder sample is between ½ and ⅔ of the measuring range, and the measuring cylinder mouth was sealed with a sealing film. The measuring cylinder loaded with the powder was placed on a mechanical vibration apparatus for 5000 vibrations at 100 times/minute to 300 times/minute, and after that, the tap density was obtained according to the mass/volume after vibration.

Carbon Content Test

A sample was combusted at a high temperature in a high-frequency furnace under an oxygen-rich condition, so that the carbon and sulfur were oxidized to form carbon dioxide and sulfur dioxide. The gas is then treated and directed to a corresponding absorption cell for absorbing corresponding infrared radiation, and then a corresponding signal was generated by a detector through conversion. This signal was sampled by a computer, linearly corrected, and converted into a numerical value which was proportional to concentrations of the carbon dioxide and sulfur dioxide. Then values taken during the entire analysis process were accumulated. After the analysis was completed, in the computer, this accumulated value was divided by the weight value, then multiplied by a correction factor, and deducted by a blank value to obtain the carbon and sulfur percent contents in the sample. The sample test was performed by using a high-frequency infrared carbon and sulfur analyzer (HCS-140, Shanghai Dekai).

I2/I1 test

XRD test: A sample of 1.0-2.0 g was weighed, poured into a groove of a glass sample holder, and compacted and smoothed with a glass sheet. Then, the sample was tested by using an X-ray diffractometer (Brook, D8) according to JJS K 0131-1996 “General Principles of X-Ray Diffraction Analysis”, with a test voltage set to 40 kV, a current to 30 mA, a scanning angle range to 10° to 85°, a scanning step to 0.0167°, and a time for each step to 0.24 second. Then, an XRD diffraction pattern was obtained from which a highest intensity value I1 when 2θ was 28.4° and a highest intensity value I2 when 2θ was 21.0° were obtained. Then, a ratio of the I2/I1 was calculated.

TABLE 1
Specific examples of material preparation and corresponding powder information

| | | Particle | | | | Addition | | | | | | |
|---|---|---|---|---|---|---|---|---|---|---|---|---|
| | | size of | Particle | | | percentage | | | | | | |
| | | silicon- | size of | Addition | Addition | of silicon- | | Content of | | Specific | | Initial |
| | Type of | based | graphite | percentage | percentage | based | | element | Carbon | surface | Gram | effi- |
| | silicon-based | particles | particles | of bitumen | of graphite | particles | | silicon | content | area | capacity* | ciency** |
| | particles | (μm) | (μm) | (%) | (%) | (%) | I2/I1 | (%) | (%) | (m²/g) | (mAh/g) | (%) |
| Example 1 | SiO | 3.5 | 3.2 | 12 | 38 | 50 | 1.38 | 31 | 49 | 2.03 | 1023 | 72.2 |
| Example 2 | SiO | 6.2 | 3.2 | 18 | 35 | 47 | 1.42 | 30 | 52 | 2.23 | 1042 | 71.5 |
| Example 3 | SiO | 6.2 | 3.2 | 8 | 40 | 52 | 1.32 | 32 | 47 | 2.20 | 998 | 70.9 |
| Example 4 | SiO | 6.2 | 3.2 | 12 | 48 | 40 | 1.56 | 25 | 59 | 2.87 | 867 | 73.5 |
| Example 5 | SiO | 6.2 | 3.2 | 12 | 58 | 30 | 1.32 | 19 | 71 | 2.60 | 735 | 74.4 |
| Example 6 | SiO | 6.2 | 3.2 | 12 | 38 | 50 | 1.43 | 31 | 49 | 2.62 | 1003 | 71.4 |
| Example 7 | SiO | 10 | 3.2 | 12 | 38 | 50 | 1.39 | 31 | 52 | 1.99 | 998 | 72.3 |
| Example 8 | SiO | 6.2 | 6.1 | 12 | 38 | 50 | 1.44 | 31 | 53 | 2.73 | 1012 | 71.6 |
| Example 9 | SiO | 10 | 6.1 | 12 | 38 | 50 | 1.39 | 31 | 52 | 2.42 | 989 | 71.7 |
| Example 10 | SiO | 10 | 9.3 | 12 | 38 | 50 | 1.29 | 31 | 48 | 2.29 | 942 | 71.7 |
| Example 11 | Mg-containing | 5.8 | 3.2 | 12 | 38 | 50 | / | 28 | 53 | 2.22 | 817 | 80.1 |
| | silicon oxide | | | | | | | | | | | |
| Example 12 | Li-containing | 5.6 | 3.2 | 12 | 38 | 50 | / | 26 | 52 | 2.29 | 862 | 84.1 |
| | silicon oxide | | | | | | | | | | | |
| Comparative | SiO | 6.2 | 9.3 | 12 | 38 | 50 | 0.78 | 31 | 48 | 2.74 | 987 | 70.7 |
| example 1 | | | | | | | | | | | | |
| Comparative | SiO | 3.5 | 3.2 | 0 | 43 | 57 | 0.84 | 35 | 54 | 2.34 | 1050 | 71.4 |
| example 2 | | | | | | | | | | | | |
| Comparative | SiO | 3.5 | 9.3 | 12 | 38 | 50 | 0.79 | 31 | 47 | 2.07 | 976 | 71.5 |
| example 3 | | | | | | | | | | | | |
| Comparative | SiO | 6.2 | 6.1 | 0 | 43 | 57 | 0.68 | 34 | 48 | 2.34 | 1047 | 71.4 |
| example 4 | | | | | | | | | | | | |
| Comparative | Mg-containing | 5.8 | 3.2 | 0 | 43 | 57 | / | 28 | 48 | 2.1 | 821 | 80.4 |
| example 5 | silicon oxide | | | | | | | | | | | |
| Comparative | Li-containing | 5.6 | 3.2 | 0 | 43 | 57 | / | 26 | 48 | 2.7 | 865 | 84.3 |
| example 6 | silicon oxide | | | | | | | | | | | |

In Table 1, the particle size refers to a median particle size. The aspect ratio of graphite particles with a median particle size of 3.2 μm is 3.3; the aspect ratio of graphite particles with a median particle size of 6.1 μm is 5.4; and the aspect ratio of graphite particles with a median particle size of 9.3 μm is 8.2. The bitumen is medium-temperature bitumen with a softening point of 200-250 degrees Celsius and a median particle size of 3.2 μm;
*Gram capacity at discharge cut-off voltage of 1.5 V in the table; and
**An initial efficiency calculation method is capacity at a discharge cut-off voltage of 1.5V/capacity at a charge cut-off voltage of 0.005 V.

The silicon oxide materials used therein are:

SiO: Silicon dioxide was mixed with silicon metal powder at a molar ratio of about 1:5-5:1 to obtain a mixed material; the mixed material was heated within a temperature range of about 1200-1450° C. for about 0.5-24 h at about 10-4-10-1 kPa to obtain a gas; the gas obtained was condensed to obtain a solid; and the solid was crushed and sifted.

The Li-containing silicon oxide or Mg-containing silicon oxide material was a SiO material with pre-embedded lithium or pre-embedded magnesium and was used herein to illustrate the material improvement effect, without specific limitation on material preparation scheme. Reference may be made to the preparation methods described in patents EP3379611A1 and CN109075330A.

II. Full Battery Estimation

1. Full Battery Test

Preparation of Lithium-Ion Battery

Preparation of positive electrode: LiCoO₂, conductive carbon black, and polyvinylidene fluoride (PVDF) at a weight ratio of about 95%:2.5%:2.5% were stirred thoroughly and mixed uniformly in a N-methylpyrrolidone solvent system to prepare a positive electrode slurry. The positive electrode slurry prepared was applied on a positive electrode current collector aluminum foil, followed by drying and cold pressing, to obtain a positive electrode.

Preparation of negative electrode: Graphite, the negative electrode active material prepared according to an example or a comparative example, a conductive agent (conductive carbon black, Super P®) and the binder PAA were mixed at a specified weight ratio to prepare a 500 mAh/g anode. An appropriate amount of water was added, and kneading was performed at a solid content of about 55%-70%. An appropriate amount of water was added to adjust the viscosity of the slurry to about 4000-6000 Pa·s to prepare a negative electrode slurry.

The prepared negative electrode slurry was applied on a negative electrode current collector aluminum foil, followed by drying and cold pressing, to obtain a negative electrode.

Preparation of electrolyte: In a dry argon atmosphere, LiPF₆ with a concentration of about 1.15 mol/L was added into a solvent obtained by mixing propylene carbonate (PC), ethylene carbonate (EC) and diethyl carbonate (DEC) (at a weight ratio of about 1:1:1) and mixed uniformly, and then about 12.5% fluoroethylene carbonate (FEC) was added and mixed uniformly to obtain an electrolyte.

Preparation of separator: A PE porous polymer film was used as a separator.

Preparation of lithium-ion battery: The positive electrode, the separator and the negative electrode were stacked in order so that the separator is located between the positive electrode and the negative electrode for separation. Then winding was performed to obtain an electrode assembly. The electrode assembly was placed in an outer package, the electrolyte was injected, and packaging was performed, followed by processes such as formation, degassing, and trimming, to obtain a lithium-ion battery.

2. Cycling Performance Test

At a test temperature of 25° C./45° C., the battery was charged to 4.4 V at a constant current of 0.7 C, constant-voltage charged to 0.025 C, left standing for 5 minutes, and then discharged to 3.0 Vat 0.5 C. A capacity obtained in this step was an initial capacity. Then, a 0.7 C charge/0.5 C discharge cycle test was performed. A ratio of a capacity at each step to the initial capacity was calculated to obtain a capacity attenuation curve. The number of cycles when a capacity retention rate was 90% at 25° C. was recorded as the room temperature cycling performance of the battery. The number of cycles when a capacity retention rate was 80% at 45° C. was recorded as a high temperature cycling performance of the battery. The cycling performance of the material was compared by comparing the number of cycles in the above two situations.

3. Discharge Rate Test

At 25° C., a battery was discharged to 3.0 V at 0.2 C, left standing for 5 minutes, charged to 4.45 V at 0.5 C, constant-voltage charged to 0.05 C, and left standing for 5 minutes. The discharge rate was adjusted, and discharge tests were performed at 0.2 C, 0.5 C, 1 C, 1.5 C and 2.0 C respectively to obtain discharge capacities. The capacity obtained at each rate was compared with the capacity obtained at 0.2 C. The rate performance was compared by comparing the ratios at 2 C and 0.2 C.

4. Full Charge Swelling Rate Test of Battery

A thickness of a half-charged (state of charge (SOC) of 50%) fresh battery was measured with a spiral micrometer. After 400 cycles, a thickness of the battery fully charged (SOC of 100%) was measured again with the spiral micrometer and compared with the initial thickness of the half-charged (SOC of 50%) fresh battery to obtain a full charge swelling rate of the (SOC of 100%) battery at that moment.

TABLE 2
Performance of full batteries with materials in examples and comparative examples

| | Cycles at 25° C. | Swelling | Cycles at 45° C. | Swelling rate of | |
|---|---|---|---|---|---|
| | when capacity | rate of battery | when capacity | battery in | |
| | retention rate | in 500^{th} | retention rate | 400^{th} cycle | |
| Examples | reaches 90% | cycle at 25° C. | reaches 80% | at 45° C. | Rate |
| Example 1 | 430 | 8.3% | 420 | 8.5% | 69% |
| Example 2 | 443 | 8.2% | 440 | 8.3% | 70% |
| Example 3 | 410 | 8.4% | 410 | 8.5% | 71% |
| Example 4 | 472 | 7.5% | 475 | 7.8% | 74% |
| Example 5 | 480 | 7.2% | 493 | 7.4% | 70% |
| Example 6 | 460 | 7.4% | 480 | 7.8% | 73% |
| Example 7 | 483 | 7.5% | 490 | 7.2% | 74% |
| Example 8 | 454 | 7.2% | 471 | 7.5% | 73% |
| Example 9 | 473 | 7.2% | 475 | 7.1% | 73% |
| Example 10 | 469 | 7.6% | 475 | 7.5% | 75% |
| Example 11 | 340 | 11.1% | 325 | 11.7% | 78% |
| Example 12 | 376 | 9.1% | 385 | 9.5% | 74% |
| Comparative | 382 | 8.6% | 427 | 9.3% | 69% |
| Example 1 | | | | | |
| Comparative | 392 | 8.8% | 390 | 8.9% | 67% |
| Example 2 | | | | | |
| Comparative | 363 | 8.9% | 400 | 9.5% | 68% |
| Example 3 | | | | | |
| Comparative | 368 | 8.8% | 395 | 9.6% | 67% |
| Example 4 | | | | | |
| Comparative | 312 | 11.3% | 305 | 13.4% | 75% |
| Example 5 | | | | | |
| Comparative | 330 | 9.5% | 355 | 9.7% | 72% |
| Example 6 | | | | | |

It can be learned from comparisons between example 1 and comparative example 2 and between example 8 and comparative example 4 that as compared with non-granulated compounding, after the graphite particles are compounded with the silicon-based particles, the cycling performance is significantly improved and the cell swelling is reduced to some extent because the material produced by composite granulation can significantly inhibit the detachment of silicon from graphite, and the rate performance is slightly improved.

In examples 2, 3, and 4, the amount of bitumen added during granulation was regulated. It can be learned from comparisons between examples 2, 3, and 4 that: an appropriate amount of bitumen is very important for granulation; when the bitumen content is low (8%), the granulation is not complete and the granulated particles formed are incomplete, and when the content is too high (18%), the degree of granulation is too large; and both forms cause some slight deterioration in performance compared to the material granulated with 12% bitumen.

In examples 7, 9, and 10, the influence of the particle size of graphite particles on the performance was regulated. It can be learned that when the graphite particles are small, there are slightly more contact sites between graphite and silicon and the contact performance is better, so the cycling performance is better, but the cell swelling performance is slightly worse because the graphite particles are slightly smaller, not conducive to suppressing the swelling; and the graphite particles being close to the silicon particles has a relatively good effect on suppressing the swelling.

It can be learned from comparisons between example 11 and comparative example 5 and between example 12 and comparative example 6 that when granulation is performed for the Li-containing silicon oxide material and the Mg-containing silicon oxide material in the same manner, relatively good results can still be achieved.

In examples 4, 5, and 6, the ratio of graphite particles to silicon-based particles was regulated. It can be learned that when there are fewer silicon-based particles, the dispersion of silicon particles in the graphite mixed system is better, so better cycling performance and lower swelling performance can be obtained with a slightly lower content of silicon-based particles.

Although illustrative embodiments have been demonstrated and described, persons skilled in the art should understand that the foregoing embodiments are not to be construed as limiting this application, and that some embodiments may be changed, replaced, and modified without departing from the spirit, principle, and scope of this application.

What is claimed is:

1. A silicon-carbon composite particle, comprising a silicon-based particle and a plurality of graphite particles on a surface of the silicon-based particle, wherein the graphite particles have a particle size of M μm, the silicon-based particle has a particle size of N μm, M<N, and 2<N≤10.

2. The silicon-carbon composite particle according to claim 1, wherein W is a number of graphite particles present on the surface of the silicon-based particle and W≥3.

3. The silicon-carbon composite particle according to claim 1, wherein 3≤N≤10.

4. The silicon-carbon composite particle according to claim 1, wherein 0.1≤M/N≤0.99.

5. The silicon-carbon composite particle according to claim 1, wherein the plurality of graphite particles have an aspect ratio of 3 to 10.

6. The silicon-carbon composite particle according to claim 1, wherein based on a weight of the silicon-carbon composite particle, a percentage of element silicon is 15% to 40%, and a percentage of element carbon is 40% to 85%.

7. The silicon-carbon composite particles according to claim 1, wherein the plurality of graphite particles comprise primary particles of graphite, sourced from one of petroleum coke graphite, coal-based coke graphite, or any combination thereof; the silicon-based particle comprises at least one of a silicon-containing compound, elemental silicon, or a mixture thereof;
and the silicon-based particles further contains element lithium and/or magnesium.

8. The silicon-carbon composite particle according to claim 1, wherein the silicon-carbon composite particle has a particle size less than or equal to 30 μm.

9. A negative electrode active material comprising the silicon-carbon composite particles according to claim 1.

10. The negative electrode active material according to claim 9, wherein a particle size distribution of the negative electrode active material particles satisfies: 0.3≤Dn10/Dv50≤1.

11. The negative electrode active material according to claim 9, wherein a highest intensity value is I2 when 2θ is in the range of 28.0° to 29.0°, and the highest intensity value is I1 when 2θ is in the range from 20.5° to 21.5°, wherein 0<I2/I1≤5.

12. The negative electrode active material according to claim 9, further comprising an oxide MeOy layer and a polymer layer, wherein the oxide MeOy layer coats at least a portion of the silicon-carbon composite particles, Me comprises at least one of Al, Si, Ti, Mn, V, Cr, Co, or Zr, and y is 0.5 to 3; the oxide MeOy layer comprises a first carbon material; and the polymer layer coats at least a portion of the silicon-carbon composite particles or the oxide MeOy layer, wherein the polymer layer contains a second carbon material;
wherein based on a total weight of the negative electrode active material, a percentage of the first carbon material is 0.1% to 10%, and a percentage of element Me by weight is 0.005% to 1%;
based on the total weight of the negative electrode active material, a percentage of the polymer layer by weight is 0.05% to 5%; and
the oxide MeOy layer has a thickness of 0.5 nm to 100 nm.

13. A preparation method of the silicon-carbon composite particle according to claim 1, comprising the following steps:
(1) mixing graphite particles, silicon-based particles, and an organic carbon source material to form a mixture, wherein the graphite particles have a particle size of M μm, the silicon-based particles have a particle size of N μm, M<N, and 2<N≤10, and wherein the organic carbon source material comprises at least one of bitumen, resin, or tar; and
(2) granulating and sintering the mixture formed in step (1).

14. The preparation method according to claim 13, wherein a softening point of the organic carbon source material is 200° C. to 250° C.

15. An electrochemical apparatus, comprising a negative electrode, the negative electrode comprises a silicon-carbon composite particle, comprising a silicon-based particle and a plurality of graphite particles on surface of the silicon-based particle, wherein the graphite particles have a particle size of M μm, the silicon-based particle has a particle size of N μm, M<N, and 2<N≤10.

16. An electronic apparatus, comprising the electrochemical apparatus according to claim 15.
